(19) United States
(12) Patent Application Publication
(10) Pub. No.: US 2026/0259944 A1
(43) Pub. Date: Sep. 3, 2026

(54) OPTIMIZATIONS FOR DATA OBJECT RETRIEVAL

(71) Applicant: Real Endpoints LLC, Florham Park, NJ (US)

(72) Inventors: Susan Warren Raiola, Morristown, NJ (US); Jeffrey Berkowitz, Livingston, NJ (US); Julia Bradshaw Murphy, Aldie, VA (US); Glenn Andrew Connery, Blue Bell, PA (US); Keith Jeremy Seim, Owen Sound (CA); Lachlan Stuyvesant Dionne, Astoria, NY (US)

(21) Appl. No.: 19/552,764

(22) Filed: Feb. 27, 2026

Related U.S. Application Data
(60) Provisional application No. 63/765,447, filed on Feb. 28, 2025.

(51) Int. Cl. G06F 16/951; G06F 16/9538; G06Q 40/00

(52) U.S. Cl. CPC G06F 16/951; G06F 16/9538; G06Q 40/00

(57) ABSTRACT

Methods, systems, and apparatus, including computer programs encoded on computer storage media, for performing query optimizations for data object retrieval. In some implementations, a server identifies a plurality of data objects from one or more sites. The server segments the plurality of data objects to sets of data objects to be retrieved in a parallel scrapping process. The server executes the parallel scraping process for each set of data objects. In response, the server analyzes, for each scraped data object, a current status of the scraped data object. The server determines whether the current status of the scraped data object is different from a previous status of the scraped data object. In response to determining the current status is different from the previous status, the server provides, to a plurality of user devices, user interface data that illustrates the current status of the scraped data object.

### CROSS-REFERENCE TO RELATED APPLICATION

This application claims the benefit of U.S. Provisional Application No. 63/765,447, filed on February 28, 2025, which is incorporated herein by reference in its entirety.

### TECHNICAL FIELD

This specification generally relates to query optimizations, and more specifically, executing query optimizations for retrieving data objects.

### BACKGROUND

As part of the healthcare process, patients may have difficulty in affording their prescription or other types of medications. Various foundational programs exist that offer financial support those patients that cannot afford their medications. However, it can be difficult to identify and locate these foundational programs when the foundational programs include varying eligibility requirements, are not easily reachable, and include funds that offer such payment without patients being aware of such funds.

### SUMMARY

In some implementations, a computer system can enhance the process of retrieving data objects for displaying to an interface, such as by performing one or more optimization techniques. The computer system can perform the one or more optimization techniques in a coordinated manner to retrieve data objects from various locations, e.g., different locations over the Internet, and without incurring additional delay. This can improve the execution speed of a computer program on the computer system and reduce overall utilization of network bandwidth. In this manner, a user reviewing the data objects on a display, for example, can review statuses related to the data objects in a real time or substantially real-time manner and without delay that would otherwise frustrate the user’s interaction with the computer system.

For example, the computer system can include a user interface platform that enables users or patients access to various funds provided by foundations. The foundations offer financial assistance to patients through the use of funds that patients can use to pay for various prescriptions, therapy, or other types of medications. On its own, identifying a foundation that works for a particular patient can be a complicated task. Each foundation can provide one or more funds and a patient needs to determine whether they are eligible for such fund. The odds that a patient can find a relevant fund that is specific to the patient’s criteria without the platform is low. Accordingly, this platform consolidates all available funds from the foundations into a single location that provides opportunity to gain access to the financial assistance they desire.

In some implementations, the computer system should display the most up-to-date information related to the data objects. These data objects can include, for example, funds from foundations provided by various organizations and other data objects that display status and corresponding information related to an organization. An issue may arise when one or more funds are displayed on the platform with outdated information. As the user scrolls through the platform searching for a specific data object, e.g., fund, a status of the data object may read “open,” enabling the user to apply for such a fund, when in fact the organization has closed access to this fund. In order to alleviate this issue, the platform can request for information from these sites that include foundations on a periodic basis. As the number of funds from the foundations grow on the platform, the computer system incurs significant delay for retrieving information from these sites. Moreover, when the computer system performs a sequential process of retrieving fund information from these sites, not only is the computer system receiving delays, which may be caused by any number of factors, but the user interacting with the computer system experiences significantly delay, frustrating their interaction with the platform.

Accordingly, the computer system can deploy one or more optimization techniques that improves the speed at which the platform operates. In particular, the computer system can retrieve fund information from these sites in a parallel processing manner. The parallel processing can be performed in a multi-threaded environment, for example, where the computer system executes a retrieval or scraping of fund information from a relevant site in one thread and executes another thread in parallel scraping of different fund information from a different or similar site. In this example, the processor utilization for the computer system is reduced in half and the results are displayed to the user in a quicker and more reliable manner. In some examples, the computer system can increase the number of threads for parallel processing as the number of data objects increase on the platform. The matching of threads of data objects, which when executed significantly reduces the network delay, processing utilization, and delay of results displayed to a user.

In some implementations, the computer system can further include an automated discovery tool. The automated discovery tool can be configured to identify, retrieve, classify, and score one or more external web-based funds prior to presenting on the platform. The automated discovery tool can include a machine learning based web crawler and an artificial intelligence scoring engine. The machine learning based web crawler can be configured to execute a search for a set of funds on the Internet associated with a particular disease, criteria, or other eligibility information. The machine learning based web crawler can iteratively retrieve link results, filter duplicate or excluded resources based on previously identified funds stored in a database system, and classify any newly discovered funds using supervised or unsupervised learning, for example.

In some implementations, the artificial intelligence scoring engine can be configured to analyze content from the linked funds retrieved by the machine learning based web crawler in order to determine whether the linked funds corresponds to search characteristics or fund criteria. The artificial intelligence scoring engine can utilize one or more large language models (LLMs) that are configured to parse the textual or graphical context, detected structured fund attributes, parse through unstructured fund attributes, and generate a confidence score indicative of a fund’s relevance to the search criteria. In some cases, the artificial intelligence scoring engine can flag a linked fund whose score does not satisfy a threshold value and store the link and corresponding flag in a database system. In some cases, the artificial intelligence scoring engine can flag a linked fund whose score does satisfy a threshold value as a fund to be processed in the database system. In this manner, the discovery tool can automatically identify funds from the Internet and score such funds for the computer system to scrape without manual user intervention.

In one general aspect, a server performs a method. The method includes: identifying a plurality of data objects from one or more sites; segmenting the plurality of data objects to sets of data objects to be retrieved in a parallel scrapping process; executing the parallel scraping process for each set of data objects; in response to executing the parallel scraping process for the set of data objects, analyzing, for each scraped data object, a current status of the scraped data object; determining whether the current status of the scraped data object is different from a previous status of the scraped data object; and in response to determining the current status of the scraped data object is different from the previous status of the scraped data object, providing, to a plurality of user devices, user interface data that illustrates the current status of the scraped data object.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, identifying the plurality of data objects from the one or more sites includes identifying a plurality of funds from the one or more sites.

In some implementations, the one or more sites includes one or more foundation sites.

In some implementations, segmenting the plurality of data objects to sets of data objects to be retrieved in the parallel scraping process includes: dividing the plurality of data objects to the sets of data objects; and generating threads for execution according to the divided sets of data objects, wherein a number of the threads are generated according to a number of the data objects in the divided sets of data objects.

In some implementations, for each set of the data objects, executing the parallel scraping process for the set of data objects includes: assigning each thread from the generated threads to each data object of the divided sets of data object; and executing each assigned thread in the parallel scraping process for the divided sets of data objects.

In some implementations, determining whether the current status of the scraped data object is different from the previous status of the scraped data object includes: determining whether the current status of the scraped data object comprises a closed or open indication; determining whether the previous status of the scraped data object comprises a closed or open indication; comparing the current status and the previous status of the scraped data object; and in response to comparing: determining the current status is different from the previous status; or determining the current status matches to the previous status.

In some implementations, providing, to the plurality of user devices, the user interface data that illustrates the current status of the scraped data object includes: generating, for each user device of the plurality of user device, the user interface data that illustrates at least the current status of the scraped data object; and transmitting, over a network and to the plurality of user devices, the generated user interface data that illustrates at least the scraped data object.

In some implementation, the method further includes: receiving, from a user device, a search query comprising one or more terms; executing, using a machine learning system, one or more search operations against one or more external resources using the received search query; obtaining, by the machine learning system, one or more candidate results based on an execution of the one or more search operations against the one or more external resources using the received search query; and providing, by the machine learning system, the one or more obtained candidate results to an artificial intelligence system prior to performing the parallel scraping process.

In some implementations, the method further includes: receiving, by the artificial intelligence system and from the machine learning system, content associated with each of the one or more obtained candidate results; generating, using the artificial intelligence system, a relevance score for each of the one or more obtained candidate results, wherein the artificial intelligence system is configured to perform a semantic analysis on a candidate result using the one or more terms of the search query; for each of the one or more obtained candidate results: comparing the relevance score for a candidate result to a threshold value; determining that the relevance score satisfies the threshold value; and in response to determining that the relevance score satisfies the threshold value, adding the candidate result to an output list; and providing the output list to a database to be utilized in the parallel scrapping process.

In some implementations, the method further includes: receiving, from the user device, classification feedback corresponding to each candidate result in the output list; and updating one or more parameters of the artificial intelligence system using the received classification feedback.

The subject matter described in this specification can be implemented in various embodiments and may result in one or more of the following advantages. In some implementations, the computer system’s optimization techniques can improve the overall processing of the platform. By executing the request or scraping of funds in a parallel manner, the computer’s total processing time is significantly reduced.

Moreover, the computer system can execute the parallel request of data objects in batches. For example, if the computer platform includes 50 data objects that require parallel retrieval, the computer system can segment the 50 data objects into batches of data objects. Each of data object can include 10 data objects. Then, the computer platform can execute the parallel processing of the 10 data objects for the total number of data objects. During the execution of the parallel processing, if one of the data objects in a batch of 10 data objects is non-responsive, for example, the computer system only experiences a delay related to the relevant batch of 10 data objects, and not the entire queue. Said another way, the 4 other batches of 10 data objects do not experience a significant delay based on the single data object that is delayed in the first batch. This technical advantage ensures that the computer system remains operating as expected and without incurring significant delay despite the single batch experiencing the non-responsiveness.

In some implementations, the discovery tool provides additional technical improvements by automating Internet fund identification and classification. A user can submit a search query to the discovery tool for a set of funds. The search query can relate to a particular disease, a state of a disease, or eligibility criteria. The discovery tool can execute a search on the Internet using the search query and can return candidate funds or candidate resources. The candidate funds can be stored in a database system for tracking purposes and enabling techniques to exclude duplicates or passing the properly identified funds to the computer system.

In some implementations, the discovery tool can include an artificial intelligence scoring engine that can analyze content associated with each of the candidate funds. The artificial intelligence scoring engine can utilize one or more large language models to process the content associated with each of the candidate funds and compute a relevance score. The discovery tool can compare the relevance score to a threshold value, which may be dynamic or user defined, and present only those funds whose score exceeds the threshold value. In this manner, the discovery tool can act without human intervention, identifying funds from the Internet, excluding duplicate resources, and scoring funds whose content is representative of the search criteria. This automated scoring and promotion process reduces the need for redundant network requests and manual search requests, which can hog the network bandwidth.

Collectively, the computer system and the discovery tool operate in a technologically enhanced environment. The enhanced environment combines parallel data retrieval, supervised link management, and artificial intelligence based contextual scoring. The computer system can perform scraping of funds in a parallelized, multithreaded environment, while dynamically filtering duplicate or low scored entries. The integration of batch scoring of funds with adaptive artificial intelligence can improve the accuracy and freshness of funds available to users. The enhanced environment can improve processor efficiency and database integrity relative to approaches that rely on manual review.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram that illustrates an example of a system for performing query optimizations for data object retrieval.

FIGS. 1B-1E illustrate examples of graphical user interfaces of data associated with the discovery tool.

FIG. 2 is a block diagram that illustrates an example of a user interfaces that show techniques for displaying updates related to the query optimizations for the data object retrieval.

FIG. 3 is a flow chart that illustrates an example process for performing query optimizations for data object retrieval.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

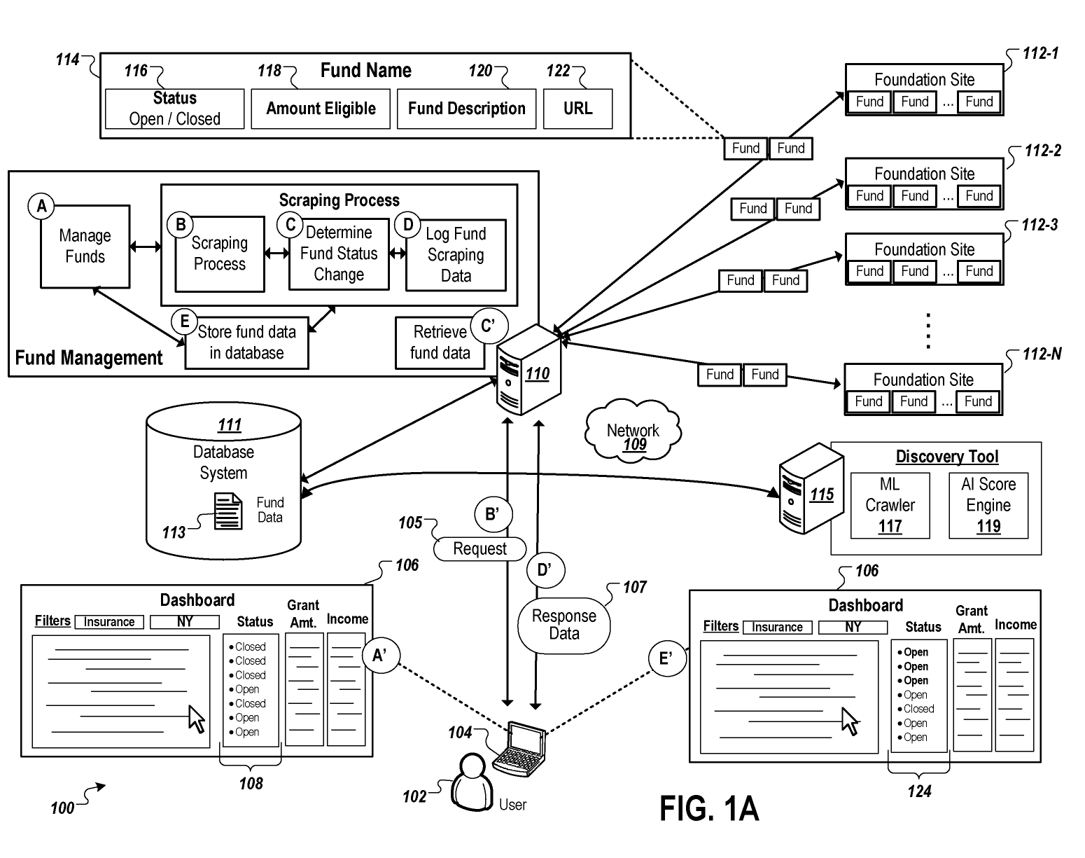

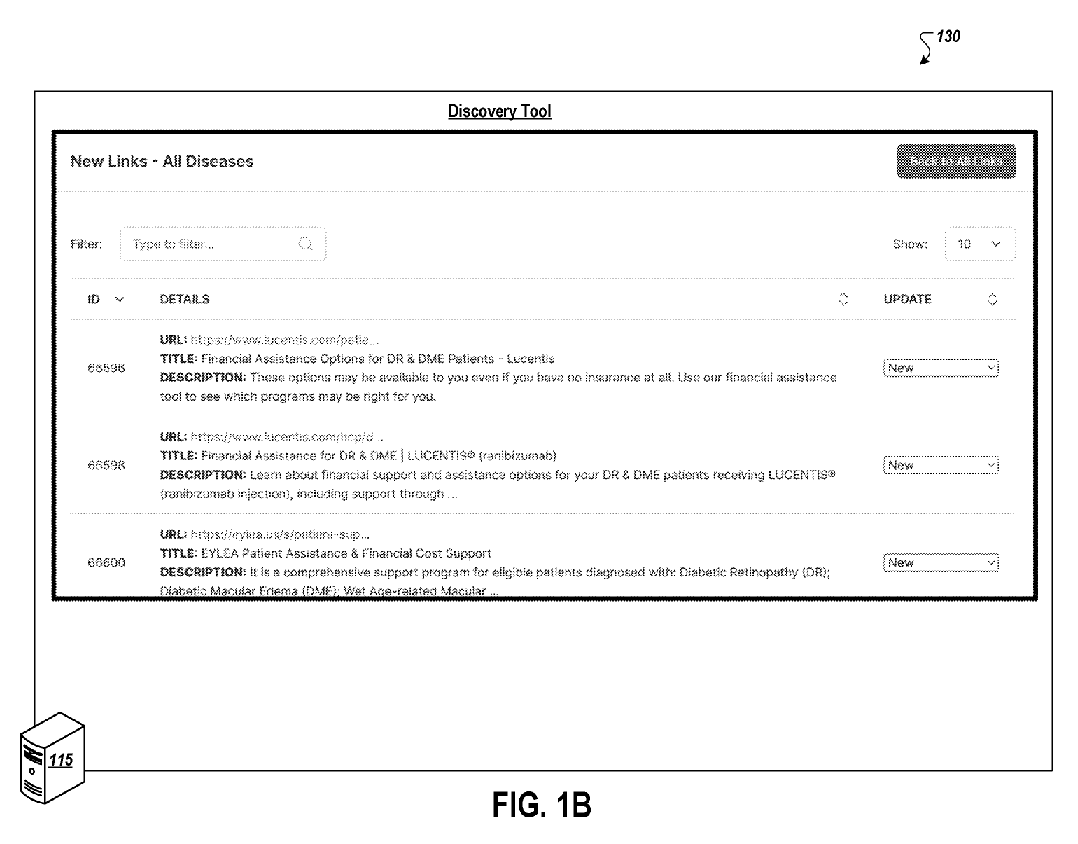

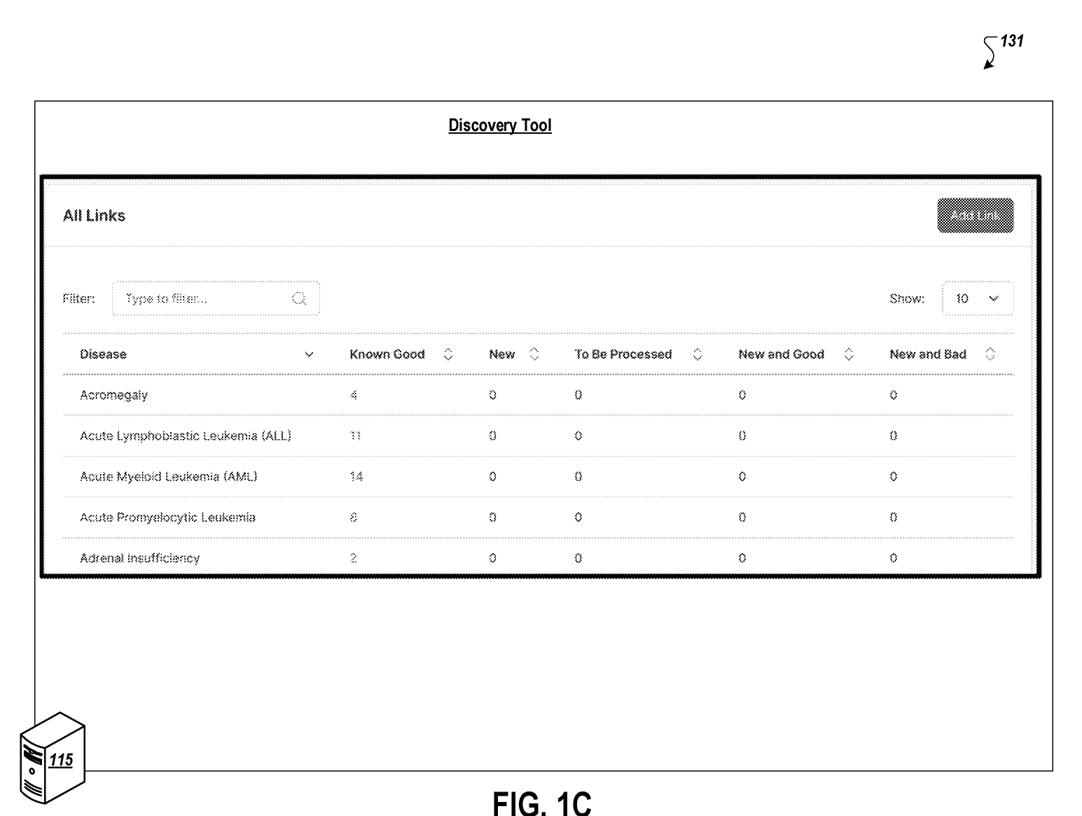

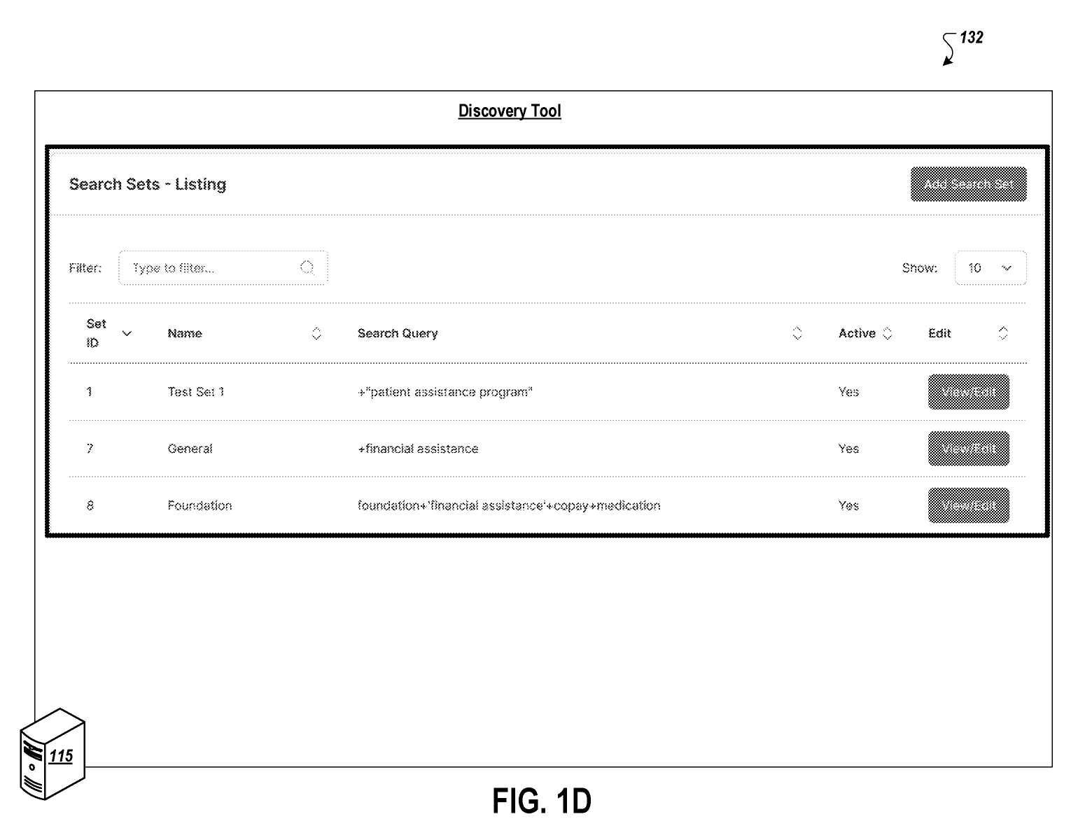

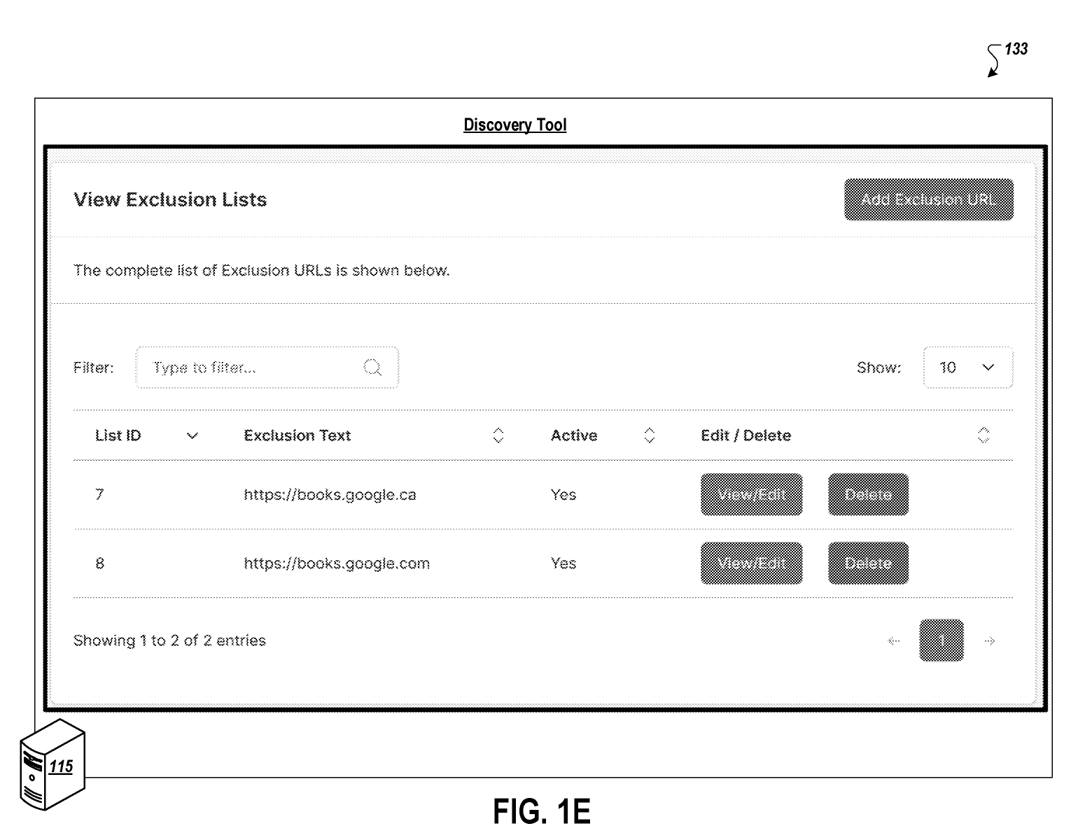

FIG. 1A is a block diagram that illustrates an example of a system 100 for performing query optimizations for data object retrieval. The system 100 includes a computer system 110, a database system 111, a discovery tool 115, and one or more foundation sites 112-1 through 112-N (hereinafter “foundation sites 112”). The system also includes a client device 104 of a user 102. The components of the system 100 communicate over a network 109, such as the Internet.

The computer system 110 can coordinate a variety of operations related to accessing, managing, and providing data objects from the foundation sites 112. The computer system 110 can retrieve data objects from the foundation sites 112, which can include retrieving data objects, e.g., one or more funds, from one or more foundation sites. The computer system 110 can store data associated with the data objects in the database system 111 as fund data 113, and use the stored data objects to track continuous use of the data objects overtime. Moreover, the computer system 110 can provide data indicative of the data objects to one or more client devices, such as client device 104, for display for user review and interaction.

In the example of system 100, the user 102 has loaded a dashboard 106 on the client device 104. The dashboard 106 in the example of system 100 includes at least text, images, visualizations, e.g., charts, graphs, etc., or other content, such as content from the fund data 113 stored by the database system 111. The computer system 110 coordinates the delivery of data to the client device 104 to load information shown in the dashboard 106, such as retrieving stored data or filtering data currently displayed on the client device 104. For example, the information displayed on the dashboard 106 can include data related to data objects, e.g., funds, and their corresponding information. The corresponding information can include, for example, a status of the fund, e.g., whether open or closed, an amount eligible to access the fund, a fund description, income requirements to access the fund, and other information related to the fund.

In some examples, a user, such as user 102, may seek to utilize the computer system 110 in trying to gain access to therapy or medication services, depending on the type of insurance available. A user who is on Medicare may have a lower annual salary and may have difficulty paying higher copays. This may be the case whether the user is a commercial patient who has a high deductible health plan and cannot afford their co-pay because they are still working on their deductible for the year. In another case, a user may have used up a manufacturer’s copay support and lack the funds able to pay for their medication. Accordingly, users seek to access computer system 110 to seek additional financial assistance, such as by way of funds, to afford their medication.

The computer system 110 displays the foundations, and specifically, their funds, which are available to provide patient access to additional financial assistance in order to gain access to medication or therapy. However, identifying foundations and searching for funds on respective foundation sites are not a trivial matter and can be difficult for an individual patient. There is difficulty in identifying which foundations the user is eligible, according to their insurance type, job type, income level, funds requested, and foundations sought after. There are various data objects or funds that a user can access, such as state funds, regional regions, and other types of funds. The odds that a user, such as user 102, can appropriately identify funds specific to their criteria may be low and extremely rare. Accordingly, the computer system 110 consolidates funds from various foundation sites into one location that give a user the greatest possible opportunity to gain access to the financial assistance they need.

Generally, a foundation site is supported by a foundation or organization that publishes grants or funds. Each foundation can include many funds that provide financial assistance to users to aid in paying for medical treatment, therapy treatment, food assistance, or other assistance, depending on a poverty level or a type of insurance held by a particular user. As illustrated in system 100, each of the foundation sites 112 include can provide one or more funds. A fund, such as fund 114, can be representative of a data object, which can be, for example, a list, a key value pair, a graph, a visualization, an array, a pointer to data, or other data types. The fund 114 includes encoded data that represents an amount of financial assistance from a corresponding foundation. The fund 114 can include, for example, a fund name, a fund status 116, an amount eligible 118, a fund description 120, a fund URL 122, and other information specifying the fund.

In some cases, user 102 can work with a call center to access the computer system 110. In particular, the user 102 can call an individual located at the call center, and the individual can access and log into the computer system 110 on behalf of the user 102. In this manner, the user 102 and the individual at the call center can work in tandem to identify one or more data objects, e.g., funds, which may be relevant to the user 102 for accessing financial assistance for a designated need. In particular, and as will be described below, the user 102 and/or the individual from the call center can enter search fields in the dashboard 106 to quickly identify one or more funds that are relevant to the user 102. The user 102 can then determine whether the results, e.g., the one or more identified funds, are open or closed, and whether the user 102 meets the eligibility criteria to obtain financial assistance from one or more of these funds.

In some implementations, user 102 can access the computer system 110 and network through a uniform resource locator (URL). The URL can be embedded into a website, such as a medical website, a pharmaceutical website, or other type of website, which enables user 102 to access the computer system 110 over the internet. In some cases, the user 102 can enter a specific URL into a web browser of their client device 104 to access the computer system 110.

With the dashboard 106 displayed at the client device 104, the computer system 110 can ensure the content shown on the dashboard 106 is maintained in a real-time or substantially near real-time fashion to provide user 102 with the most up-to-date information. As will be further described below, the computer system 110 can achieve maintaining up-to-date content shown in the dashboard 106 by sending requests for data from various sites for fund information in an optimized fashion. The resultant data from the various sites can be stored in the database system 111 for tracking purposes and provided for display on the dashboard 106, as shown in the example of system 100.

The example of FIG. 1A includes stages (A) to (E), which represent various operations and a flow of data, and which can occur in the order illustrated or in a different order, and may include fewer or additional operations. Similarly, the example of FIG. 1A includes another process of stages (A’) to (E’), which represent various operations and another flow of data, and which can occur in the order illustrated or in a different order, and may include fewer or additional operations. For example, the process of stages (A) to (E) may be performed followed by the process of stages (A’) to (E’). Other examples are also possible.

The computer system 110 can be implemented using one or more servers, such as one or more cloud computer systems, one or more on-premises servers, etc. For, example, the computer system 110 can be an application server. The computer system 110 can provide front-end functionality to interface with various client devices over network 109. For example, the computer system 110 can provide content to display on an interface of the client devices or an interface that includes content to the client devices. The interface can include, for example, an application programming interface (API), a user interface, e.g., by providing user interface data for a web page, a web application, or another type of application, or another type of interface.

The database system 111 can provide various data retrieval, storage, and processing functions. For example, the database system 111 can be a database management system (DBMS) and can include the capability to process operations specified in structured query language (SQL), Python code, C++ code, or in other types of forms. The database system 111 has access to various datasets, e.g., fund data 113, cached data, and other data types, which can include private datasets for various organizations, such as a foundation or other companies. The database system 111 can store and use these datasets in various forms, such as relational database tables, data cubes, data sets, or other forms.

The database system 111 can store data that identifies a start time and an end time associated with queries for performing the scraping. For example, the database system 111 can store a query ID, timestamps for each query, a duration time, and data identifies references that provide transparency and visibility. By storing, in an auditability manner, fund information, data associated with queries, and data associated with scraping, the system 100 can expose any potential vulnerabilities related to any process performed by the computer system 110 and any other components.

The database system 111 can store the funds in an efficient caching system. The caching system maximizes resource utilization and minimizes redundant server calls, and thereby improving system performance. For example, the computer system 110 randomizes data retrieval based on unique fund IDs to prevent simultaneous requests to the same URLs and reduces the risk of server bottlenecks or slowdowns. The computer system 110 relies on a generated page cache table with the unique URL for the fund and a timestamp that tracks the last update time for each URL. When the computer system 110 requests a particular URL, the computer system 110 checks the cache for the URL’s timestamp. If the cached data is older than a threshold number of minutes, a new page is fetched and the cache in the database system 111 is updated. Each time a page is retrieved from the URL, the computer system 110 records the new page in the cache table with the URL as the unique key, which ensures only one entry per URL in the cache. However, a cache purging can occur at the beginning of accessing the URLs, and outdated entries will be removed to maintain cache efficiency and data accuracy. If the computer system 110 determines that a URL exists in the cache on a second call within the specified time frame, the cached data is used directly, bypassing the timestamp check. This reduces redundant data fetching, ensuring efficient use of resources.

In some implementations, different users of system 100 can have access to different datasets, e.g., different funds, depending on their roles, permissions, or eligibility. The user 102 authenticates to computer system 110, so that the user’s identity is determined, the user’s permissions are determined, and the user 102 initiates a session for interacting with the computer system 110. In some implementations, the users of system 100 can each have access to the different datasets.

In the example of FIG. 1A, in stage (A’), the client device 104 displays a view of the dashboard, with content derived from the various sites. The current view of the dashboard 106 shows a page of a dashboard with various types of content, e.g., filters, text, visualizations, status information 108, grant amount information, and maximum income information. The computer system 110 generated the content shown in the dashboard 106 based on data retrieved from various sites, various devices, or other systems. This process will be further described below.

For example, as part of loading the dashboard 106 and serving it to the client device 104, the computer system 110 requested or retrieved fund data 113 from the database system 111, received the fund data 113, and provided content based on the fund data 113, e.g., a visualization or information describing the fund data 113, to the client device 104 over the network 109 for display in the dashboard 106. The fund data 113 represents data processing results which was obtained from the computer system 110 querying various sites, such as the foundation sites 112-1 through 112-N (hereinafter “foundation sites 112”). The result of the query includes various fund data retrieved from the foundation sites 112 and stored in the database system 111.

After the dashboard 106 view is shown to the user 102, the user 102 can interact with the various interface elements on the dashboard 106 to curate certain results. In some examples, the user 102 can add certain one or more filters to the dashboard 106 that curates or generates results automatically for the user 102 to view. The user 102 can interact with a user interface element with a mouse click, a touchscreen press with a finger, a vocal command to the client device 104, or another manner.

For example, the user 102 can interact with specific features of the funds shown on the dashboard 106. The specific features of the funds can include a name of the fund, a description of the fund, description of the foundation that provides the fund, a status of the fund, a grant amount of the fund, and a maximum income amount for using the fund. The dashboard 106 illustrates a column of status information 108 of statuses for each fund, a column of the grant amount, a column for the maximum income amount, and a corresponding column describing each of the founds. The column of status information 108 may change, and provide the user 102 with an indication of whether the fund is open to use or not open.

The user 102 can interact with a filter box and enter criteria information relevant to the user 102. For example, the user 102 can enter information to the filters to search for specific funds. The information can include, for example, an insurance type held by the user 102, the type of financial support requested, a state where the user 102 is located or is residence, a number of persons in the user 102’s household, and a household income.

In response to entering the information in the filter box, the dashboard 106 can generate a curated list of funds according to the filtered criteria provided by user 102. The dashboard 106 can update the list of funds according to the filtered information in real time or substantially near real time. In some examples, the dashboard 106 can list the funds in alphabetical order, according to the name of the fund. The funds can list the URL, which provides the user with access to a specific foundation site, e.g., foundation 112-3 for example, related to a selected fund. In some examples, each fund can include a time and date associated with when the fund was last updated at the computer system 110.

In some implementations, the computer system 110 displays the fund data 113 on the dashboard 106 in a compliant manner. A manufacturer is required to provide a list of every foundation and their corresponding funds, and to inform various users of the availability of foundation assistance. This requires that the list of every foundation and their corresponding funds be presented in a non-biased manner. As such, the computer system 110 ensures the funds are displayed to users on their respective client devices in a compliant manner. For example, the computer system 110 displays the funds from each of the foundations on the dashboard 106 in a compliant manner, such as by alphabetical order. Moreover, compliance requires that the dashboard 106 be displayed with each of the funds prior to filtered criteria information. For example, the computer system 110 populates the dashboard 106 with each of the funds, and then enables user 102 to narrow the list on the dashboard 106 according to their specified criteria. A computer system 110 is said to be non-compliant if the computer system 110 displayed an empty list of funds on the dashboard 106, then allowed a user 102 to search for funds that were subsequently populated on the dashboard 106. Accordingly, the computer system 110 displays each of the funds first on the dashboard 106, then allows user 102 to narrow the list of funds according to their specified criteria.

In some implementations, the dashboard 106 is a dynamic document that changes content when the underlying data in the fund data 113 changes. The computer system 110 can refresh the data shown on the dashboard 106, when the fund data 113 changes, and accordingly, refresh the text, images, and/or any visualizations in the dashboard 106 when the fund data 113 changes, or when the dashboard 106 is re-loaded or re-opened.

In stage (B’), the client device 104 transmits a request 105 to the computer system 110 over the network 109. The request 105 can include various types of information that describe the state of the current view of the dashboard 106 (e.g., which portion of the page is in view) as well as the scope of data that the user 102 is interested in or interaction with (e.g., the current filter settings applied, which elements are selected by the user 102, etc.). The information in the request 105 provides information that facilitates the computer system 110’s creation of a list of funds to be displayed for the dashboard 106, and for the current view of the dashboard 106 as experienced by the user 102. For example, the generated request 105 can include a session identifier for the current session of viewing the dashboard 106, a dashboard identifier for the dashboard 106, a user selection status (e.g., indicating if any user interface elements have been highlighted or selected, identifiers for selected elements, information related to any filters applied), a client device identifier for the client device 104, and other data.

The session identifier can represent a unique identifier that the computer system 110 assigns for the current session of the client device 104 providing the dashboard 106, or more generally of interacting with the computer system 110 based on the authentication of the user 102. The dashboard identifier can represent a number, a value, an index, or another data type that represents the current view of the dashboard 106. The user selection status can include an identifier or element index value that specifies an element that is currently selected (e.g., highlighted, being interacted with, or entered) by the user 102 in the dashboard 106. Moreover, the user selection status can include information related to the filtered data, e.g., a textual description. The client device identifier can include data that identifies the client device 104 that transmitted the request 105, e.g., an IP address or other identifying information. The request 105 can include a list of funds currently displayed on the dashboard 106 and their status.

In stage (C’) the computer system 110 receives the request 105 over the network 109. The computer system 110 extracts data from the request 105 to retrieve, for example, the session identifier, the dashboard identifier, the user selection status, the client device identifier, and other data. With this information, the computer system 110 can determine the appropriate fund information that the computer system 110 (or in some cases another system) is serving to the client device 104, as well as the particular funds of the dashboard 106 being displayed to or interacted with by the user 102. The computer system 110 can also determine the filtered information applied by the user 102 to the dashboard 106.

Additionally, from the request 170, the computer system 110 can analyze the user selection status to determine which user interface element of the dashboard 106, if any, were selected at the time by the user 102. If so, then the computer system 110 can limit the data scope to the selected elements on the dashboard 106 or limit any updates to the information according to the selected elements, so that other non-selected elements may be excluded from updating or processing. For example, based on the filtered information and the funds currently displayed by the dashboard 106, the computer system 110 can determine which of the funds are currently displayed. In some examples, the computer system 110 can seek to update the funds on the dashboard 106 regardless of the current view of the dashboard 106 by the user 102.

The computer system 110 retrieves the fund data 113 from the database system 111. The fund data 113 can include any changes to the funds retrieved from the one or more foundation sites 112. In some implementations, the process for identifying funds for scraping, executing the scraping process, and storing data associated with the scraped funds is described below with regards to the process described in stages (A) through (E). In some implementations, the process for identifying funds can be performed alternatively or in conjunction with stages (A) through (E), by a discovery tool 115 that is configured to automatically identify funds. In some cases, the discovery tool 115 can identify funds, scrape data from the identified funds, and store the scraped data related to the funds in the database system 111. In some cases, the discovery tool 115 can identify relevant funds and provide data that represents or points to the relevant funds to the computer system 110. In the latter case, the computer system 110 can scrape the funds based on data pointed to by the discovery tool 115.

In some implementations, the discovery tool 115 can execute automated search operations against an external resource, e.g., foundation sites identified on the Internet, to identify potential funding opportunities. The discovery tool 115 can utilize the data provided in the request 105 to execute the automated search operations. The data provided in the request 105 may include, for example, a search string that describes a set of eligibility, disease criteria, or other for one or more funds to identify. The discovery tool 115 can execute the search and identify one or more candidate funds. The discovery tool 115 can scrape the content of funds to perform a scoring operation on each of the one or more candidate funds, generate one or more resource pointers to those scored funds that correspond to the location of those scored funds, and store those resource pointers of the candidate funds in the database system 111.

These resource pointers can be stored in the database system 111 and supplied to or retrieved by the computer system 110. The computer system 110 can selectively retrieve or scrape fund data according to the resources identified by the discovery tool 115. This selection and retrieval can reduce repetitive scraping of funds across multiple foundation sites 112, and decrease processor utilization and reduce unnecessary network requests.

In some implementations, the discovery tool 115 can scrape the content of funds whose score satisfies the threshold value. The scraped content can be stored in the database system 111 for storage. In particular, the discovery tool 115 can identify candidate funds according to search criteria, score the candidate funds as a result of an execution of the search, compare the funds score to a threshold value, scrape content of funds whose score satisfies the threshold value, and provide the scraped content of those funds directly to the database system 111 for storage. These scraped funds can then be provided as response data 107 to the user 102. This process will be further described below.

Based on the retrieved fund data from the database system 111, the computer system 110 generates response data 107. The response data 107 can include text, images, visualizations, code, mark-up data, etc. to be displayed on the dashboard 106. In some cases, the computer system 110 reduces the amount of network bandwidth by sending only the detected changes from the funds, rather than the entire graphical user interface of the dashboard itself. This not only reduces the amount of data to be sent but also reduces the time taken to send the data from the computer system 110 to the client device 104 over the network 109. Each of these detected fund changes is stored and tracked in the fund data 113 of the database system 111 for future comparisons.

In stage (D’), the computer system 110 transmits the generated response data 107 to the client device 104 over the network 109, where the response data 107 is derived from the information scraped in parallel from each of the foundation sites 112 and the detected changes from the fund data 113. In some cases, before pushing the changes to the client device 104, the computer system 110 can validate that any markup language content or code provided is functional, works properly, and does not present a security risk for the client device 104 to display.

In stage (E’), the client device 104 receives and displays the response data 107. The client device 104 can present the response data 107 for the current view of the dashboard 106. In the example of system 100, the dashboard 106 illustrates a column 124 of statuses for each fund. The column 124 of statuses for each fund shown on the dashboard 106 in stage (H) is different from the column of status information 108 for each fund shown on the dashboard 106 of stage (A). Accordingly, the user 102 can infer that the statuses of the changed funds indicates that the corresponding foundations for those funds either activated or deactivated those funds. The dashboard 106 saves the user 102 time by viewing each of the funds and their corresponding status in a single location and filtering by the user’s own geographic and/or economic situation without having to separately search for and evaluate each of these funds, which may not be possible if the user 102 is unaware that such funds exist.

If user 102 desires to export the funds list shown on the dashboard 106, the user 102 can download a Portable Document Format (PDF) of the funds list or export the funds list as another data format. The information contained in the exported file can include the following components, for example, foundationName, diseaseName, state, insurance_type, support_type, description, check_for_change_date, pediatric_fund, grant_amount, frequency, grant_amount_description, income_requirement_max_fpl, income_requirement_description, application_requirements, website_url, application_url, status, query_method, query_state, create_date, foundation_State, fundState, query_time_duration, and query_error_type.

In stage (A), the computer system 110 can manage the funds from each of the foundation sites 112. In some examples, the funds can be stored as fund data 113 in the database system 111 in an indexed fashion. In some examples, the funds can be stored as fund data 113 in the database system 111 in other fashions, e.g., in a database management system or in key-value pairs.

In some implementations, the computer system 110 can determine which of the funds to be scraped from one or more foundation sites 112. In some examples, the computer system 110 can determine each of the funds stored in the fund data 113 in the database system 111 is to be scraped from the foundation sites 112. In some examples, the computer system 110 can determine funds to be scraped according to the user 102’s view of the dashboard 106. The computer system 110 can perform various types of analyses to identify which of the funds displayed on the dashboard 106 correspond to which of the foundation sites 112. Generally, the computer system 110 can use the name of the funds as indexes to access the corresponding foundation name in the database system 111. For example, the computer system 110 can use the name of a fund “Hope Lodge®” displayed on dashboard 106 to access to a foundation name of “American Cancer Society” stored in the fund data 113 in the database system 111. Based on the identified foundation name, the computer system 110 can access a URL of the corresponding foundation address or site of https://www.cancer.org. The computer system 110 can identify the corresponding foundation address for each of the funds displayed on the dashboard 106. In some cases, the computer system 110 can access a foundation address corresponding to a respective foundation site 112 for each of the publicly available foundations. In some cases, the computer system 110 can use the URL of a corresponding foundation address or site to access a name of the fund as indexes in the database system 111.

In some cases, the computer system 110 may receive a new fund from a user that accesses the system 100. The user may provide data that represents the new fund, such as, the foundation that provides the new fund, a website associated with the new fund, a current status of the new fund, an amount eligible for the new fund, a fund description, and any other information associated with the new fund. In response to receiving the new fund from the user, the computer system 110 can store information associated with the new fund in the fund data 113 of the database system 111 in stage (E). The computer system 110 can also store new funds in the database system 111 when a foundation site publishes a new fund or remove funds from the database system 111 when the foundation site deactivates a fund. Other examples are also possible.

In stage (B), the computer system 110 can perform the scraping process. The scraping process includes, for example, extracting funds from each of the foundation sites 112 according to the identified foundation addresses identified in stage (A). Here, the computer system 110 can perform one or more optimizations to improve the process of extracting funds from each of the foundation sites 112. Using the foundation address information, the computer system 110 can access the foundation site 112 and retrieve information related to each of the funds provided by the foundation site. In some implementations, the computer system 110 can perform fund extraction from each of the foundation sites 112 in a sequential manner. However, as the number of funds managed by the computer system 110 increases, the computer system 110 may experience speed and bandwidth bottleneck issues.

For example, if the number of funds across the foundation sites 112 is greater than 400, and the process of extracting or scraping a fund from each of the foundation sites 112 requires approximately 4.5 seconds, than the total amount of time to perform the scraping for each fund is greater than 1,800 seconds (or 30 minutes). This bottleneck can significantly frustrate the user 102 experience with the dashboard 106 and any other users accessing a dashboard. In order to significantly improve the network delay, processing utilization, and bandwidth utilization of performing the extraction or scraping, the computer system 110 can perform the extracting or scraping of funds in a parallel manner.

The computer system 110 can generate a set number of threads for the total number of funds to scrape and execute the set number of threads in an iterative fashion. For example, if the computer system 110 determines there are 400 funds to scrape from each of the foundation sites 112, then the computer system 110 can generate ten threads for ten funds, and execute the scraping for those ten threads, and perform this process (of generating a set of threads for a set of funds and executing the scraping for those ten threads) iteratively until all 400 hundred threads are scraped. The computer system 110 can generate a processing thread that executes a scraping or extracting function for a single fund from a respective foundation. Once the ten threads are generated for each of ten different funds, the computer system 110 executes the scraping for each of the ten different funds in the ten threads in parallel. In some examples, the computer system 110 can use a different number of threads than ten to execute the scraping in parallel. In some implementations, the computer system 110 can provide a bulk action feature that allows a user to change the query status method for performing scraping multiple funds simultaneously.

When executing a scraping function in a thread, the computer system 110 accesses a particular foundation, e.g., foundation site 112-1, and retrieves a fund corresponding to the identified fund in the fund data 113. For instance, the computer system 110 can retrieve from the foundation site 112-1 information pertaining to the fund, e.g., the fund status 116, the amount eligible 118, the fund description 120, the fund URL 122, and other fund information, to determine whether the foundation site 112-1 has changed any of the information. Generally, the fund status 116, which indicates whether the fund is open or closed, may change, and this information needs to be reflected on the dashboard 106 shown to the users. In this manner, the user 102 can have real time or substantially near real time of information that indicates whether the fund is available to the user, e.g., fund status is open, or whether the fund is not available to the user, e.g., fund status is closed.

The computer system 110 can execute the scraping functions in each thread to reduce the overall time for the number of funds. In some cases, if one fund is slow in returning the fund status information for a particular batch of funds, e.g., ten funds, due to an error on the corresponding foundation site or another error, then the other sets of batches executed on respective threads are not affected. Accordingly, the 300 threads, e.g., thirty sets of ten batches of threads for the different funds, from the entire queue of 400 threads are not affected by the one batch of threads, e.g., one set of ten batches of threads for the different funds, due to the error. In this manner, the computer system 110 ensures that the processing continues without significantly affecting the systems’ performance due to network delays.

The computer system 110 can store data in the database system 111 when an error occurs. For example, the data can include an error type, detailed error information, timestamp of the failure, and additional context information. The error type can indicate whether the type of error is associated with the query failure. The detailed error information can capture and log detailed information about the error. The timestamp of the failure can include the exact time when the failure occurred. The additional context information can include any relevant context to assist in diagnosing the failure. Moreover, the computer system 110 can store the average time taken for queries with the error, the specific error types, e.g., 404 (Not found), Host not found, DNS errors, etc.). The computer system 110 can enable displaying of the errors, such as displaying the corresponding error message for quick reference and troubleshooting when a user moves his/her mouse over each query entry for the fund on a dashboard 106, for example.

As shown in the example of system 100, the computer system 110 executes in parallel each thread in a batch by performing a scraping function at the respective foundation site, e.g., foundation site 112-1, and returns the corresponding fund to the computer system 110. The computer system 110 can reduce the overall processing time by performing the batch processing of scraping from 30 minutes, down to 10 minutes or less, for example, depending on the number of scrapes to be performed. The computer system 110 can perform other optimizations, as will be further described below. In response to receiving the fund from each of the foundation sites 112, the computer system 110 can store the fund in the fund data 113 in the database system 111 in an indexed fashion.

In some implementations, the computer system 110 may determine that in response to scraping a fund from a particular foundation that the particular foundation site 112 has removed the fund because the fund no longer exists. If this is the case, then the computer system 110 can update the status of the fund data 113 in the database system 111 to indicate the requirement for manual intervention, such as during stage (E).

In stage (C), in response to performing the fund scraping from each of the foundation sites 112, the computer system 110 can determine whether a status of the scraped fund changed from a previous status. The computer system 110 can identify a prior version of a stored fund from the fund data 113 of the database system 111 and retrieve its contents. The contents can include, for example, fund status 116, amount eligible 118, fund description 120, fund URL 122, and other fund information. The computer system 110 can compare the retrieved contents of the prior version of the stored fund to contents of the same fund most recently scraped from a corresponding foundation site. Specifically, the computer system 110 can compare the status, the amount eligible, the fund description, and the URL, between two versions of the same fund to determine whether the corresponding foundation site pushed any changes.

For example, the computer system 110 may determine that status of the prior version of the fund was “Open” and the status of the recently scraped fund is “Closed”. The computer system 110 can determine that foundation corresponding to the foundation site closed this corresponding site.

During stage (D), the computer system 110 can store the fund information in the fund data 113 in the database system 111 in an indexed fashion, e.g., according to the fund name or some other identifier. Generally, the fund information can be stored each time the computer system 110 scrapes the funds from the foundation sites 112. In some cases, the computer system 110 can store the fund information in the fund data 113 without overwriting previous funds in order to track changes in fund information overtime.

In some implementations, the identification of funds for scraping during stage (B) may be alternatively performed by the discovery tool 115. In some implementations, the identification of funds for scraping may be performed by the discovery tool 115 in conjunction with the operations performed in stages (A) through (D). The discovery tool 115 can include a machine learning crawler 117 and an artificial intelligence (AI) score engine 119. The discovery tool 115 can be configured to receive search criteria from the user device 104 specified by user 102, e.g. a search delimited query with key terms, and execute a search to automatically identify candidate funds using the received search criteria. The discovery tool 115 can submit the search criteria to the search process to identify the candidate funds, retrieve associated fund data, and store the retrieved fund data in the database system 111.

In some implementations, the machine learning crawler 117 can perform one or more processes for managing funds. In particular, the machine learning crawler 117 can submit one or more structured search queries to one or more external search interfaces and retrieve structured search results corresponding to one or more candidate funds. The machine learning crawler 117 can store the search results of the one or more candidate funds in the database system 111 for storage and filtering purposes. The machine learning crawler 117 can evaluate the search results against previously stored fund data. In some cases, the machine learning crawler 117 can analyze the newly received funds against funds stored in the database system 111 to prevent duplicates from being restored, exclude newly identified funds that have been previously rejected, and store newly discovered funds not previously found.

In some implementations, the machine learning crawler 117 can be trained as a machine learning system using historical classification data. For example, the machine learning system can be trained using supervised classification information derived from prior user interactions with previously discovered funds. For example, when a candidate fund is classified as a user as relevant, irrelevant, inactive, or otherwise categorized, the corresponding classification data is stored in the database system 111. The machine learning crawler 117 may access this stored classification data to update internal model parameters in order adjust its internal weights and filtering of subsequently received fund data. As a result, the machine learning crawler 117 can improve its performance for identifying funds exhibiting characteristics similar to previously accepted funds and excluding candidate funds that exhibit characteristics similar to previously rejected funds.

In some implementations, the machine learning crawler 117 can utilize several types of classification techniques to train classification models using labeled data to improve fund discovery over time. For example, in a supervised learning approach, a model is trained on labeled data, where both the inputs and desired outputs are known. The goal is for the model to learn a mapping of inputs to outputs and to make predictions on new, unlabeled data. In some implementations, the machine learning crawler 117 can utilize several types of unsupervised learning techniques to train classification models to group classification funds according to shared attributes. In some implementations, reinforcement learning techniques may be utilized, where the machine learning crawler 117 can adjust crawling behavior by interacting with an environment and receiving performance feedback derived from the fund selection, e.g., rewards or penalties. Despite the type of classification techniques used to train the machine learning crawler 117, the machine learning crawler 117 iteratively learns to improve fund identification and scraping over time.

For example, the machine learning crawler 117 can be trained using a supervised approach with historical classification data derived from prior user interactions with previously discovered funds. When the computer system 110 identifies and presents one or more funds to the user 102 at the user device 104, the computer system 110 may receive data from the user 102 or other users that indicates whether the fund is relevant, irrelevant, inactive, or otherwise categorized, to name some classification examples. The computer system 110 can store the classification data in the database system 111. The discovery tool 115 can access the stored classification data along with the corresponding fund in the database system 111 to train or update the machine learning crawler 117. Overtime, the machine learning crawler 117 can improve its identification and classification of funds to prioritize candidate funds that exhibit similar characteristics to previously accepted funds and reject candidate funds that exhibit characteristics to previously rejected funds. Based on this type of training, the machine learning crawler 117 can reduce the likelihood of identifying lower relevant funds and improve the likelihood of detecting more relevant funds.

In some implementations, the discovery tool 115 can receive the search query from the user device 104. The search query may include a set of parameters delimited by one or more logical operators that signal to the machine learning crawler 117 the relationships between the parameters. For example, the one or more logical operators can include AND, OR, XOR, NOT, or other types of operators. An example search query may recite “foundation + asthma + financial assistance + copay + medication,” where the “+” can represent a logical AND operation. In some cases, the example search query can include different types of logical operators between consecutive words. The search query can be stored in the database system 111 along with a user profile or session representative of the user 102 in order to guide the machine learning crawler 117 in training.

The machine learning crawler 117 can submit the search query to one or more external resources. The external resource may include, for example, an application programmable interface (API), search provider interfaces, foundation site endpoints, or other structured data interfaces over a network. For example, the API may correspond to an API that can return search results of uniform resource locators (URLs) representative of funds corresponding to the input search queries. In some cases, the machine learning crawler 117 can receive structured search results including URLs, page titles, metadata descriptions, related contextual information, and other information representative of one or more funds found in the search results.

In some implementations, the machine learning crawler 117 can receive batches of results. For example, the external resource can return a first batch of search results corresponding to a first page of results. The external resource can follow the first batch of search results with additional result pages. The machine learning crawler 117 can iteratively request additional batches until a defined amount is satisfied or until the external resource no longer provides further search results.

For batch of results provided by the external resource, the machine learning crawler 117 can evaluate each returned item, e.g., URL, against data stored in the database system 111. The evaluation may included determining whether the returned item corresponds to an already or previously discovered resource, a previously excluded resource, a new resource, or a new candidate fund. If the returned item corresponds to a previously classified resource, then the machine learning crawler 117 can remove that item from the batch of results to avoid redundant processing. Alternatively, if the returned item corresponds to a new candidate fund, then the machine learning crawler 117 can forward that candidate fund to the AI score engine 119.

In some implementations, the machine learning crawler 117 can perform a preliminary analysis on each fund of the batch of funds. For example, the preliminary analysis may include identifying keywords that match to one or more keywords of the search criteria, identifying structural characteristics of web pages that match to previously accepted funds, and identifying other attributes relevant to the search funds. The results of the preliminary analysis can be provided to the AI score engine 119 to enhance the scoring of the corresponding funds. For example, the results of the preliminary analysis may include an initial ranking of relevance or a preliminary score of relevance to aid the AI score engine 119.

In some implementations, the machine learning crawler 117 can provide each of the identified candidate funds to the AI score engine 119. In some cases, the machine learning crawler 117 can provide the AI score engine 119 with data associated with the candidate fund. The data associated with the candidate fund can include, for example, a URL, a page title, metadata description of the corresponding page, a domain associated with the page, and the results of any preliminary analysis generated by the machine learning crawler 117.

In response to receiving the candidate funds, the AI score engine 119 can retrieve content associated with each of the candidate funds. The retrieved content can include content found within the webpage of the fund. For example, the retrieved content can include HTML content, text content, table content, structured form data, linked data, metadata found on the webpage, data describing the funds, and other contextual information related to the location of the fund. In some cases, the AI score engine 119 can normalize the retrieved content by removing data unrelated to the fund itself. For example, the AI score engine 119 can remove data that formats the textual or graphical information related to the fund for displaying on the webpage. As a result, the AI score engine 119 can retrieve the textual or graphical information from the normalized data associated with the fund for performing a semantic analysis.

In some implementations, the AI score engine 119 can compare the retrieved normalized content against fund information found within the database system 111. The fund information found within the database system 111 can include, for example, fund eligibility requirements, disease identifiers, medicine identifiers, funding amounts, application status indicators, geographic information related to fund restrictions, copay requirements, and other fund characteristics. The AI score engine 119 can determine whether the retrieved normalized content includes fund information previously identified in the database system 111. If the AI score engine 119 does find a match to previously identified fund information in the database system 111, then the AI score engine 119 can appropriately weigh the retrieved normalized content according to the match.

In some implementations, the AI score engine 119 can include one or more trained models to perform semantic parsing of the fund content and score the semantic parsed content. The trained models of the AI score engine 119 can include transformer based language models, classification models, neural network models, or other types of machine learning models that are configured to identify and score relevant fund information.

The AI score engine 119 can take as input the parsed content information and output a relevance score for the corresponding candidate fund. In particular, the AI score engine 119 can be trained to detect one or more predefined fund attributes within the parsed content and generate a weighted value for each of the detected attributes of the corresponding candidate fund. The weighted value for each of the detected attributes can be generated according to a relationship between the detected attribute and the one or more terms in the search criteria. The AI score engine 119 can assign or generate a higher weighted value for a detected attribute that exhibits a higher semantic similarity to one or more of the terms in the search criteria. Alternatively, the AI score engine 119 can assign or generate a lower weighted value for a detected attribute that exhibits lower similarity to the one or more of the terms in the search criteria. The AI score engine 119 can generate a composite relevance score by applying, e.g., summing, multiplying, normalizing, or performing any other operation on each of the weighted values for the corresponding candidate fund. The compositive relevance score may be expressed as a number between 1 and 100, or another range of numbers. The composite relevance score can represent the relevance of that candidate fund relative to the user provided search criteria.

The AI score engine 119 can compare the composite relevance score for each candidate fund to a threshold value. The threshold value may correspond to a user defined threshold value or a dynamically allocated threshold value that is determined based on prior user analyses. If the AI score engine 119 determines that the composite relevance score for a corresponding candidate fund satisfies the threshold value, e.g., meets or exceeds the threshold value, then the discovery tool 115 may automatically initiate a scraping of the candidate fund and store the retrieved fund data in fund data 113 in the database system 111. In some cases, if the AI score engine 119 determines that the composite relevance score for the corresponding candidate fund satisfies the threshold value, then the discovery tool 115 may store the URL to the candidate fund in the database system 111. In this case, the discovery tool 115 can notify the computer system 110 of the newly identified candidate fund and automatically perform the scraping process. This can be an iterative process for each of the candidate funds whose score satisfies the threshold value.

If the composite relevance score does not satisfy the threshold value, then the AI score engine 119 may exclude the corresponding candidate fund from further processing, e.g., not presenting this corresponding candidate fund to the user 102. In some implementations, candidate funds that fall within a threshold distance of the threshold value may be flagged as requiring manual review instead of exclusion. In this manner, user 102 can review these candidate funds to determine their relevance to the search criteria.

In some implementations, the AI score engine 119 can iteratively adjust scoring weights based on prior outcomes. For example, the AI score engine 119 can adjust weighting parameters to avoid subsequent false positive classifications. If the AI score engine 119 scores a candidate fund as satisfying the threshold value but then receives a classification from the user 102 that that candidate fund is actually irrelevant, then the AI score engine 119 can adjust its parameters to reduce similar false positive detections. In this manner, the AI score engine 119 can continuously improve its scoring methodology over time using user feedback, the automatic detection, and the scoring process.

In some implementations, the computer system 110 may generate dashboard data representative of the candidate funds identified by the discovery tool 115. In particular, the dashboard data can include the candidate funds identified by the discovery tool 115, their corresponding composite relevance scores, and metadata associated with each of the candidate funds. Additionally, the dashboard data can display attribute level scores associated with each of the candidate funds. This dashboard data can be displayed in the dashboard 106 on the user device 104. The dashboard 106 can dynamically update the dashboard data as the discovery tool 115 identifies new candidate funds, scores new candidate funds, and scrapes data from each of the newly identified candidate funds whose score satisfy the threshold value.

In some implementations, the AI score engine 119 can utilize multiple trained models in a chained configuration. For example, a first model of the AI score engine 119 can perform contextual parsing and extracting from the received fund content. The extracted data from the received fund content can then be provided to a second model that can evaluate the structured data to compute a relevance score related to the search criteria. By chaining multiple models together, each model can be configured for a specific purpose, allowing each model to be appropriately tuned for a particular function or feature.

In some implementations, the discovery tool 115 can operate asynchronously in relation to stages (A’) through (E’) and (A) through (E). For example, the machine learning crawler 117 and the AI score engine 119 can execute on different processing schedules than the processing schedule executed by the computer system 110 performing dashboard updates and fund scraping. In some cases, the funds identified by the discovery tool 115 can be placed in a queue in the database system 111 for ingestion by the computer system 110. In this manner, the discovery tool 115 is decoupled from the computer system 110. The discovery tool 115 and the computer system 110 can work in tandem without necessarily depending on one another to scale workloads and without having to provide competing resources for processor and network resources.

In some implementations, the computer system 110 can store changes of the scraped fund information. In some examples, the computer system 110 can iteratively compare contents of a recently scraped fund to contents of a prior version of the same fund for each of the funds. If any changes are detected or determined, then the computer system 110 can store the changes in the fund data 113 for the respective fund. By saving only the changes in the fund data 113 and not replacing the entire fund, the computer system 110 can reduce the amount of processing cycles required for storing information in the database system 111.

If the computer system 110 receives a request from a connected client device, e.g., client device 104, then the computer system 110 can retrieve the fund data 113 from the database 111 and provide that information in response to the connected client device, as described with respect to stages (A’) through (E’).

The system 100 can repeat the processes discussed above for stages (A’) through (E’) each time user 102, client device 104, or computer system 110 triggers the creation of new fund data to be displayed on the dashboard 106 of the client device 104. Additionally, the process of stages (A’) through (E’) can be performed independently and in parallel to provide different fund information for each of multiple different client devices that each have their own dashboards loaded and have their own views displayed, with different filters and selections applied and different content in view on their respective client devices.

Similarly, the system 100 can repeat the processed discussed above for stages (A) through (E) in a periodic fashion, such as every 1 second, 5 seconds, 10 seconds, or other. In this manner, the fund data 113 is updated periodically with the latest fund information provided by the foundation sites 112. Accordingly, if the computer system 110 receives a request from a connected client device for fund data, then the computer system 110 can retrieve the latest fund information to provide to the connected client device for a user’s review. Additionally, the process of stages (A) through (E) can be performed independently, in parallel, and sequential to the process of stages (A’) through (E’).

FIG. 1B illustrates an example of a graphical user interface 130 of data associated with the discovery tool. The graphical user interface 130 illustrates the different candidate funds produced by the discovery tool 115. Each candidate fund may include a uniform resource locator (URL), a title, a metadata description, and an update field. The update field allows a user to assign a classification state to the corresponding item, such as new, previously known, irrelevant, ready for processing, excluded, or other. The user selected classification may be stored in the database system 111 and used to update the fund data utilized by the machine learning crawler 117. In some implementations, these user selected classifications can be used as labeled data to train the machine learning crawler 117 and the AI score engine 119.

FIG. 1C illustrates another example of a graphical user interface 131 of data associated with the discovery tool. The graphical user interface 131 illustrates a summary of each of the links identified for one or more diseases. Each row can correspond to a particular disease or search criteria, and columns can represent classification states. The classification states can be known good, new, to be processed, new and good, and new and bad. In some examples, a user can select the classification state for each of the funds. In some examples, the discovery tool 115 can assign the classification state for each of the funds. A count can be displayed under each column that indicates the number of links identified within the corresponding classification state for the corresponding disease. The graphical user interface 131 can be dynamically updated using the scraped fund data stored in the database system 111 and updated in response to classification changes or new funds identified.

FIG. 1D illustrates another example of a graphical user interface 132 of data associated with the discovery tool. The graphical user interface 132 illustrates a management of various search queries executed by the discovery tool 115. Each search query may be associated with a query name and may include one or more logical operators and key terms that correspond to disease identifiers, fund eligibility, and other parameters. The dashboard may include an indicator specifying whether a given query is active, inactive, or to be deleted. In some implementations, active queries may be executed iteratively or on a scheduled configuration. On the other hand, inactive queries may be excluded from being executed until moved to active. Each of these queries can be stored in the database system 111 and associated with a quota level, execution interval or periodicity, to enable precise control over the queries.

FIG. 1E illustrates another example of a graphical user interface 133 of data associated with the discovery tool. The graphical user interface 133 displays the candidate funds that are excluded from being utilized. Each entry shown on the graphical user interface 133 can include a list identifier, the URL associated with the candidate fund, whether the exclusion is active or inactive, and whether to view, edit, or delete the entry in the exclusion list. During operation, the machine learning crawler 117 and the AI score engine 119 can reference the entries in the exclusion list to ensure any newly identified funds that match to these entries are excluded from further processing. Additionally, the entries in the exclusion list can be modified by administrators or other users of the system.

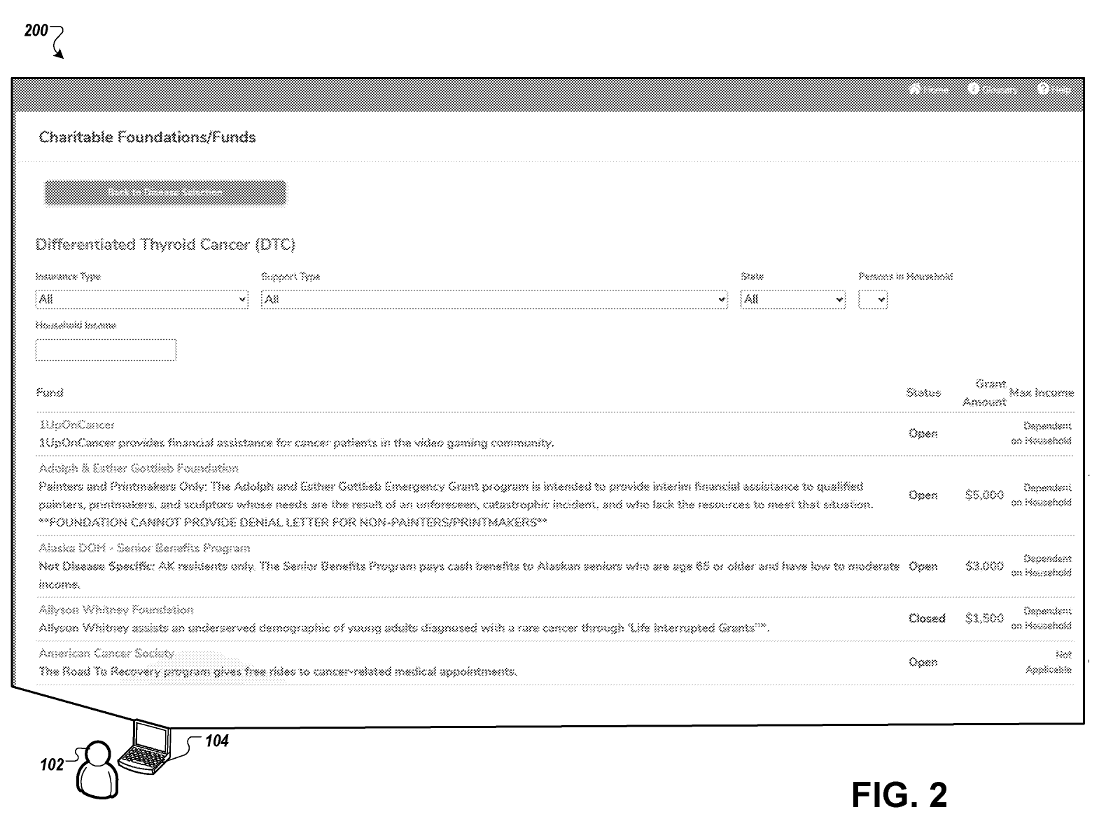

FIG. 2 is a diagram that illustrates an example of a user interface 200 that shows techniques for displaying updates related to the query optimizations for the data object retrieval. The user interface 200 is an example of a dashboard a user may see on their client device, such as dashboard 106. In particular, the user interface 200 illustrates different types of charitable foundations and their corresponding funds for a particular medical issue. In this example, the medical issue is differentiated thyroid cancer (DTC).

The user interface 200 includes various filters to enable searching through the different funds. The various filters include, for example, insurance type, support type, state, persons in household, and household income. Initially, the user interface 200 lists all the funds available, e.g., indicative of “All” entered in the insurance type, the support type, and the state, to be compliant. However, the user may enter different filter text or values into these fields to further narrow down the fund list. Moreover, the user can view the status of each fund, e.g., “Open” or “Closed,” a Grant Amount, and a Max Income amount.

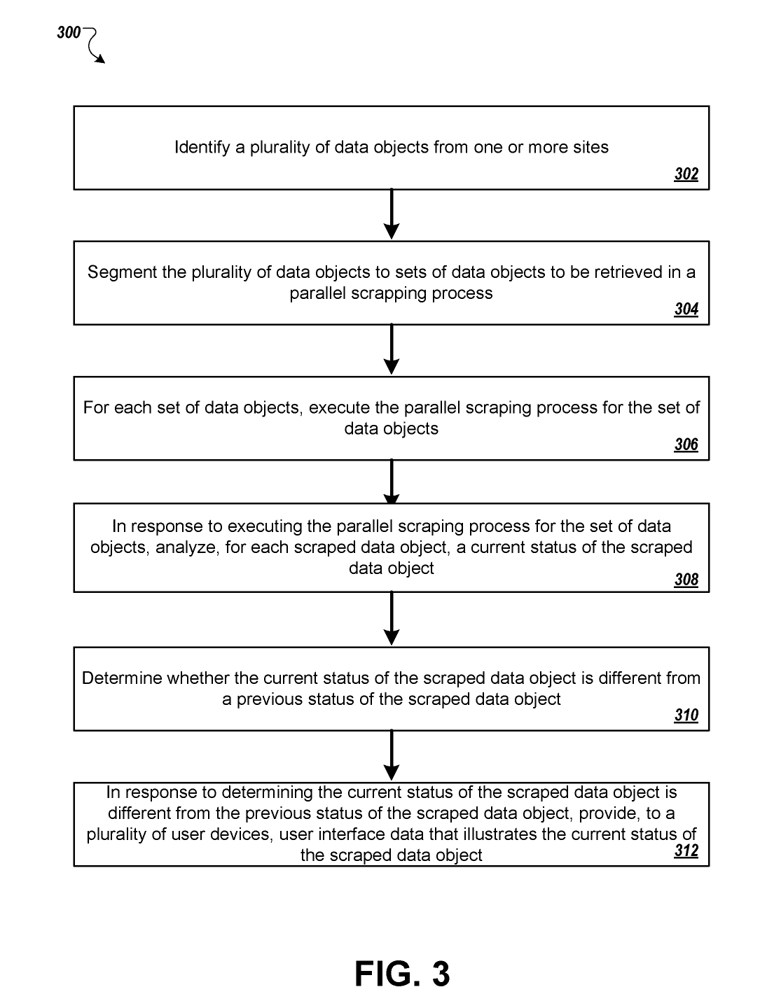

FIG. 3 is a flow chart that illustrates an example process 300 for performing query optimizations for data object retrieval. The computer system 110 can perform the process 300.

The computer system identifies a plurality of data objects from one or more sites (302). The computer system identifies a plurality of funds from the one or more sites. The one or more sites can include, for example, one or more foundation sites.

The computer system segments the plurality of data objects to sets of data objects to be retrieved in a parallel scrapping process (304). The computer system segments the plurality of data objects by dividing the plurality of data objects to the sets of data objects. Then, the computer system generates threads for execution according to the divided sets of data objects. A number of threads are generated by the computer system according to a number of the divided sets of data objects.

For each set of data objects, the computer system executes the parallel scraping process for the set of data objects (306). Here, the computer assigns each thread from the generated threads to each data object of the divided sets of data object. In response, the computer system executes each assigned thread in the parallel scraping process for the divided sets of data objects.

In response to executing the parallel scraping process for the set of data objects, the computer system analyzes, for each scrapped data object, a current status of the scraped data object (308). The computer system can extract, from the scraped data object, a status, an amount eligible, a fund description, and a URL that corresponds to a location of a fund on a foundation site.

The computer system determines whether the current status of the scraped data object is different from a previous status of the scraped data object (310). The computer system can determine whether the current status of the scraped data object includes a closed or open indication. The computer system retrieves a previous version of the scraped data object from its database system for making a comparison to the current status of the scraped data object. In response to retrieving the previous version of the scraped data object, the computer system can compare the current status of the scraped data object to a previous status of the previous version of the scraped data object retrieved from the database system. In response to performing the comparison, the computer system can determine whether current status is different from or matches to the previous status.

In response to determining the current status of the scraped data object is different from the previous status of the scraped data object, the computer system provides, to a plurality of user devices, user interface data that illustrates the current status of the scraped data object (310). In particular, the computer system can generate the user interface data that illustrates at least the current status of the scraped data object. The user interface data can also include the amount eligible, the fund description, and the URL for the fund. In some cases, the user interface data can include the information that changed between the current scraped data object and the previous version of the scraped data object. In response, the computer system transmits, over a network and to the plurality of user devices, the generated user interface data that illustrates at least the scraped data object.

In some implementations, a discovery tool can receive a search query that includes one or more terms. The discovery tool can include a machine learning system and an artificial intelligence system. The discovery tool can execute, using the machine learning system, one or more search operations against one or more external resources using the received search query. The machine learning system can obtain one or more candidate results based on an execution of the one or more search operations against the one or more external resources using the received search query. In response, the machine learning system can provide the one or more obtained candidate results to an artificial intelligence system prior to performing the parallel scraping process.

In some implementations, the artificial intelligence system can receive content associated with each of the one or more obtained candidate results from the machine learning system. The artificial intelligence system can generate a relevance score for each of the one or more obtained candidate results, the artificial intelligence system is configured to perform a semantic analysis on a candidate result using the one or more terms of the search query. For each of the one or more obtained candidate results, the artificial intelligence system can compare the relevance score for a candidate result to a threshold value and determine that the relevance score satisfies the threshold value. In response to determining that the relevance score satisfies the threshold value, the artificial intelligence system can add the candidate result to an output list in a database. The artificial intelligence system can provide the output list to a database to be utilized in the parallel scrapping process.

In some implementations, the discovery tool can receive classification feedback corresponding to each candidate result in the output list. The discovery tool can update one or more parameters of the artificial intelligence system using the received classification feedback for retraining.

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer-readable medium for execution by, or to control the operation of, data processing apparatus. The computer readable medium may be a non-transitory computer readable storage medium, a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the invention may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the invention may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the invention, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method performed comprising:
identifying a plurality of data objects from one or more sites;
segmenting the plurality of data objects to sets of data objects to be retrieved in a parallel scrapping process;
executing the parallel scraping process for each set of data objects;
in response to executing the parallel scraping process for the set of data objects, analyzing, for each scraped data object, a current status of the scraped data object;
determining whether the current status of the scraped data object is different from a previous status of the scraped data object; and
in response to determining the current status of the scraped data object is different from the previous status of the scraped data object, providing, to a plurality of user devices, user interface data that illustrates the current status of the scraped data object.

2. The computer-implemented method of claim 1, wherein identifying the plurality of data objects from the one or more sites comprises identifying a plurality of funds from the one or more sites.

3. The computer-implemented method of claim 1, wherein the one or more sites comprises one or more foundation sites.

4. The computer-implemented method of claim 1, wherein segmenting the plurality of data objects to sets of data objects to be retrieved in the parallel scraping process comprises:
dividing the plurality of data objects to the sets of data objects; and
generating threads for execution according to the divided sets of data objects, wherein a number of the threads are generated according to a number of the data objects in the divided sets of data objects.

5. The computer-implemented method of claim 4, wherein for each set of the data objects, executing the parallel scraping process for the set of data objects comprises:
assigning each thread from the generated threads to each data object of the divided sets of data object; and
executing each assigned thread in the parallel scraping process for the divided sets of data objects.

6. The computer-implemented method of claim 1, wherein determining whether the current status of the scraped data object is different from the previous status of the scraped data object comprises:
determining whether the current status of the scraped data object comprises a closed or open indication;
determining whether the previous status of the scraped data object comprises a closed or open indication;
comparing the current status and the previous status of the scraped data object; and
in response to comparing:
determining the current status is different from the previous status; or
determining the current status matches to the previous status.

7. The computer-implemented method of claim 1, wherein providing, to the plurality of user devices, the user interface data that illustrates the current status of the scraped data object comprises:
generating, for each user device of the plurality of user device, the user interface data that illustrates at least the current status of the scraped data object; and
transmitting, over a network and to the plurality of user devices, the generated user interface data that illustrates at least the scraped data object.

8. The computer-implemented method of claim 1, further comprising:
receiving, from a user device, a search query comprising one or more terms;
executing, using a machine learning system, one or more search operations against one or more external resources using the received search query;
obtaining, by the machine learning system, one or more candidate results based on an execution of the one or more search operations against the one or more external resources using the received search query; and
providing, by the machine learning system, the one or more obtained candidate results to an artificial intelligence system prior to performing the parallel scraping process.

9. The computer-implemented method of claim 8, further comprising:
receiving, by the artificial intelligence system and from the machine learning system, content associated with each of the one or more obtained candidate results;
generating, using the artificial intelligence system, a relevance score for each of the one or more obtained candidate results, wherein the artificial intelligence system is configured to perform a semantic analysis on a candidate result using the one or more terms of the search query;
for each of the one or more obtained candidate results:
comparing the relevance score for a candidate result to a threshold value;
determining that the relevance score satisfies the threshold value; and
in response to determining that the relevance score satisfies the threshold value, adding the candidate result to an output list; and
providing the output list to a database to be utilized in the parallel scrapping process.

10. The computer-implemented method of claim 9, further comprising:
receiving, from the user device, classification feedback corresponding to each candidate result in the output list; and
updating one or more parameters of the artificial intelligence system using the received classification feedback.

11. A system comprising:
one or more computers and one or more storage devices storing instructions that are operable, when executed by the one or more computers, to cause the one or more computers to perform operations comprising:
identifying a plurality of data objects from one or more sites;
segmenting the plurality of data objects to sets of data objects to be retrieved in a parallel scrapping process;
executing the parallel scraping process for each set of data objects;
in response to executing the parallel scraping process for the set of data objects, analyzing, for each scraped data object, a current status of the scraped data object;
determining whether the current status of the scraped data object is different from a previous status of the scraped data object; and
in response to determining the current status of the scraped data object is different from the previous status of the scraped data object, providing, to a plurality of user devices, user interface data that illustrates the current status of the scraped data object.

12. The system of claim 11, wherein identifying the plurality of data objects from the one or more sites comprises identifying a plurality of funds from the one or more sites.

13. The system of claim 11, wherein the one or more sites comprises one or more foundation sites.

14. The system of claim 11, wherein segmenting the plurality of data objects to sets of data objects to be retrieved in the parallel scraping process comprises:
dividing the plurality of data objects to the sets of data objects; and
generating threads for execution according to the divided sets of data objects, wherein a number of the threads are generated according to a number of the data objects in the divided sets of data objects.

15. The system of claim 14, wherein for each set of the data objects, executing the parallel scraping process for the set of data objects comprises:
assigning each thread from the generated threads to each data object of the divided sets of data object; and
executing each assigned thread in the parallel scraping process for the divided sets of data objects.

16. The system of claim 11, wherein determining whether the current status of the scraped data object is different from the previous status of the scraped data object comprises:
determining whether the current status of the scraped data object comprises a closed or open indication;
determining whether the previous status of the scraped data object comprises a closed or open indication;
comparing the current status and the previous status of the scraped data object; and
in response to comparing:
determining the current status is different from the previous status; or
determining the current status matches to the previous status.

17. The system of claim 11, wherein providing, to the plurality of user devices, the user interface data that illustrates the current status of the scraped data object comprises:
generating, for each user device of the plurality of user device, the user interface data that illustrates at least the current status of the scraped data object; and
transmitting, over a network and to the plurality of user devices, the generated user interface data that illustrates at least the scraped data object.

18. The system of claim 11, further comprising:
receiving, from a user device, a search query comprising one or more terms;
executing, using a machine learning system, one or more search operations against one or more external resources using the received search query;
obtaining, by the machine learning system, one or more candidate results based on an execution of the one or more search operations against the one or more external resources using the received search query; and
providing, by the machine learning system, the one or more obtained candidate results to an artificial intelligence system prior to performing the parallel scraping process.

19. The system of claim 18, further comprising:
receiving, by the artificial intelligence system and from the machine learning system, content associated with each of the one or more obtained candidate results;
generating, using the artificial intelligence system, a relevance score for each of the one or more obtained candidate results, wherein the artificial intelligence system is configured to perform a semantic analysis on a candidate result using the one or more terms of the search query; and
for each of the one or more obtained candidate results:
comparing the relevance score for a candidate result to a threshold value;
determining that the relevance score satisfies the threshold value; and
in response to determining that the relevance score satisfies the threshold value, adding the candidate result to an output list; and
providing the output list to a database to be utilized in the parallel scrapping process.

20. A non-transitory computer-readable medium storing software comprising instructions executable by one or more computers which, upon such execution, cause the one or more computers to perform operations comprising:
identifying a plurality of data objects from one or more sites;
segmenting the plurality of data objects to sets of data objects to be retrieved in a parallel scrapping process;
executing the parallel scraping process for each set of data objects;
in response to executing the parallel scraping process for the set of data objects, analyzing, for each scraped data object, a current status of the scraped data object;
determining whether the current status of the scraped data object is different from a previous status of the scraped data object; and
in response to determining the current status of the scraped data object is different from the previous status of the scraped data object, providing, to a plurality of user devices, user interface data that illustrates the current status of the scraped data object.
